(19) United States
(12) Patent Application Publication
(10) Pub. No.: US 2026/0086818 A1
(43) Pub. Date: Mar. 26, 2026

(54) Firmware Download for Physical Layer of Peripheral Interface

(71) Applicant: Apple Inc., Cupertino, CA (US)

(72) Inventors: John H. Kelm, Belmont, CA (US); Michael Bekerman, Los Gatos, CA (US); Christopher D. Finan, Cupertino, CA (US); Josh P. de Cesare, Campbell, CA (US); Yu Chen, Santa Clara, CA (US)

(21) Appl. No.: 19/042,934

(22) Filed: Jan. 31, 2025

Related U.S. Application Data
(60) Provisional application No. 63/699,233, filed on Sep. 26, 2024.

(51) Int. Cl. G06F 9/4401

(52) U.S. Cl. CPC G06F 9/4411

(57) ABSTRACT

An apparatus may include a computer system that includes one or more processor circuits configured to execute boot code, a physical interface circuit, and a physical interface controller circuit. The physical interface circuit may be configured to operate in a plurality of modes, including firmware-based, first hardware-based, and second hardware-based modes. The physical interface controller circuit, may be coupled to one or more memory circuits, and may be configured to, upon a boot of the computer system, operate the physical interface circuit in the first hardware-based mode to load, from a storage device, at least a first portion of boot code into a first memory circuit. After execution of the first portion of the boot code, the physical interface controller circuit may be further configured to operate the physical interface circuit in the second hardware-based mode to load firmware into a second memory circuit.

### PRIORITY CLAIM

The present application claims priority to U.S. Provisional Application No. 63/699,233, entitled “Firmware Download for Physical Layer of Peripheral Interface,” filed Sep. 26, 2024, the disclosure of which is incorporated by reference herein in its entirety.

### BACKGROUND

### Technical Field

Embodiments described herein are related to integrated circuits (ICs) and, more particularly, to a computer system boot operation via a peripheral interface.

### Description of the Related Art

Computer systems may utilize one or more standardized interfaces to enable additional circuits to be added to the computer system. For example, serial advanced technology attachment (SATA) interfaces may be used to attach one or more hard-disk or solid-state drives to a computer system. Universal serial bus (USB) interfaces may be used to attach a wide array of peripherals (e.g., keyboards, mice, speakers, cameras, thumb drives, and the like) to the computer system. Peripheral Component Interconnect Express (PCIe) interfaces may be used to add graphics cards, sound cards, Ethernet, Wi-Fi, and other similar circuits to the computer system. PCIe interfaces may be used to add and/or increase support for other interfaces such as a SATA card or USB card. Use of standardized interfaces may allow a computer system to use a variety of existing hardware from various vendors that is compatible with the same standard.

Maintenance and development of these standards is commonly performed by a standards committee which may include membership from a plurality of industry manufacturers. Accordingly, development and release of a new version of an existing standard may not coincide with a given companies product schedule. The given company may therefore limit support for a given standard to versions that exist at the time of the given companies new product development, which may limit expansion options and or capabilities for an end-user of the new product.

### BRIEF DESCRIPTION OF THE DRAWINGS

The following detailed description makes reference to the accompanying drawings, which are now briefly described.

FIG. 1 illustrates a block diagram of an embodiment of a computer system with a physical interface circuit used in a boot operation.

FIG. 2 shows a block diagram of another embodiment of a computer system with a peripheral component interconnect express (PCIe), having two PCIe channels, wherein one PCIe channel is used in a boot operation.

FIG. 3 depicts a block diagram of an embodiment of a computer system with a two PCIe circuits, wherein one PCIe circuit is used in a boot operation.

FIG. 4 shows a flow diagram of an embodiment of a method for booting a computer system using a physical interface circuit.

FIG. 5 illustrates a flow diagram of an embodiment of a method for rebooting a computer system using a physical interface circuit.

FIG. 6 depicts various embodiments of systems that include coupled integrated circuits.

FIG. 7 shows a block diagram of an example computer-readable medium, according to some embodiments.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

### DETAILED DESCRIPTION OF EMBODIMENTS

As disclosed above, when designing a new integrated circuit (IC) design that includes support circuitry for a particular standardized interface, the support circuitry may be limited for use with existing standard as published at the time the new IC is designed. In some cases, however, it may desirable to include support for unpublished and/or unratified features of the standardized interface. For example, the standards committee may be considering one or more features for inclusion in a next generation of the standard. In such cases, an IC designer may consider including support for one or more of the potential features if adequate details are available. In other examples, next generation features may be known and ratified but early adopters of the next generation may desire to include a level of adjustment in the respective ICs to allow for compensation for new circuit designs that may not be completely compatible with the published standard.

As an example, peripheral component interconnect express (PCIe) generation (gen) 5 schemes are more complex than earlier generations, with gen 5 supporting higher bit rates and multibit signaling, thereby increasing risk associated with implementing gen 5 support in hardware. Accordingly, a new PCIe controller circuit may be designed with additional circuitry to, e.g., enable adjustments to timing strobes for receiving data and/or adjustments to timing for transitioning signal edges for transmitting data. Once method for enabling such adjustability in an IC design, as disclosed herein, includes addition of a microcontroller (MCU) to handle these adjustments. Use of an MCU may allow a manufactured version of the IC to be modified by downloading updated firmware for use by the MCU. Inclusion of such an MCU, however, may require an associated technique for downloading the firmware upon a boot of the IC.

In addition, inclusion of a PCIe controller in an IC may also warrant support for boot via a PCIe interface channel since a PCIe interface may be coupled to one or more storage devices. Using an interface controller circuit that requires downloading firmware to enable full support of the PCIe standards leads to further complication since firmware load may be performed as part of a boot operation. In some embodiments, a consistent view of the firmware download across all IC platforms may be desired. Such consistency may simplify the boot code, thereby reducing for support for boot operation verification as well as opportunities for errors.

Accordingly, the present disclosure proposes a computer system that includes an IC with a processor circuit, a physical interface circuit, and a physical interface controller circuit. The physical interface circuit may operate in a plurality of modes, including a firmware-based mode, as well as first and second hardware-based modes. The physical interface controller circuit may, upon a boot of the computer system, operate the physical interface circuit in the first hardware-based mode to load at least a first portion of boot code from a storage device coupled to the physical interface circuit. After execution of the first portion of the boot code by the processor circuit, the physical interface controller circuit may operate the physical interface circuit in the second hardware-based mode, which may be faster than the first hardware-based mode, to load communication firmware. By utilizing one or more hardware-based modes, a physical interface circuit that supports at least one firmware-based mode may be usable as a boot device despite not having the firmware loaded to support the additional modes.

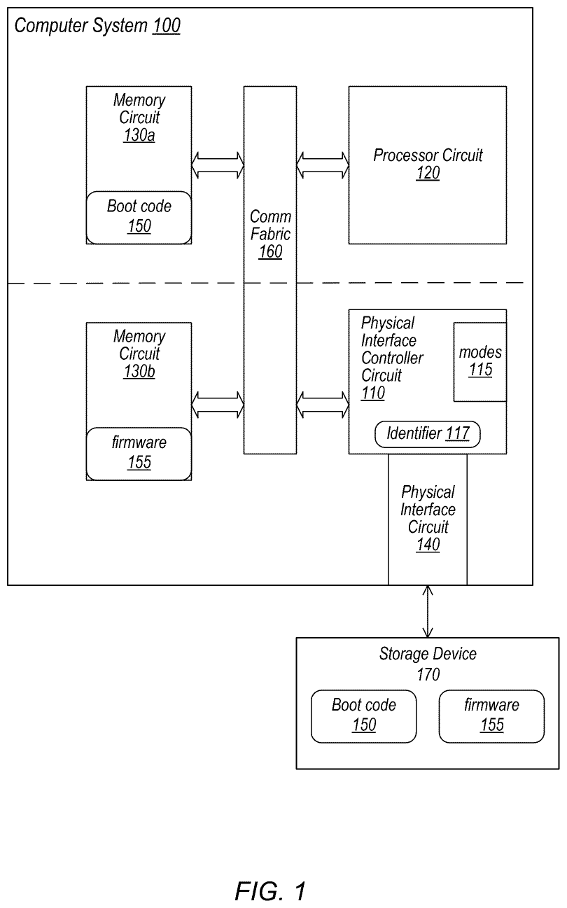

FIG. 1 illustrates a block diagram of an embodiment of a system that uses a physical interface circuit that utilizes firmware to perform a boot operation. Computer system 100 includes processor circuit 120, memory circuits 130a and 130b (collectively 130), and physical interface circuit 140 coupled to storage device 170 that is shown as external to computer system 100. In other embodiments, storage device 170 may be included, in whole or in part, within computer system 100. Computer system 100 further includes physical interface controller circuit 110 that supports a plurality of modes 115, including at least two hardware-based modes and at least one firmware-based mode.

As illustrated, computer system 100 may be a desktop or laptop computer, a smartphone, a tablet computer, a wearable smart device, or the like. In some embodiments, computer system 100 is implemented on a single integrated circuit (IC), or a multi-die chip with circuits distributed across two or more IC dies, such as indicated by the dashed line. In such multi-die embodiments, two or more of the IC dies may be co-packaged and configured to operate as a single IC across the plurality of co-packaged integrated circuit dies. Such individual die comprising a multi-die IC are referred to herein as “chiplets.” It is to be understood that any SOC or computer system disclosed herein can be implemented using a chiplet-based architecture. Accordingly, wherever the term “SOC” or “computer system” or simply “system” appears in this disclosure, those references are intended to also suggest embodiments in which the same functionality is implemented via a less monolithic architecture, such as via multiple chiplets, which may be included in a single package in some embodiments.

On a related note, such multi-die embodiments are to be understood to encompass both homogeneous designs (in which each SOC includes identical or almost identical functionality) and heterogeneous designs (in which the functionality of each SOC diverges more considerably). Such disclosure also contemplates embodiments in which the functionality of the multiple SOCs is implemented using different levels of discreteness. For example, the functionality of a first system could be implemented on a single IC, while the functionality of a second system (which could be the same or different than the first system) could be implemented using a number of co-packaged chiplets.

Computer system 100, as shown, includes processor circuit 120 that may be configured to execute boot code to perform a boot sequence for computer system 100. In other embodiments, one or more additional processor circuits may be included. In various embodiments, processor circuit 120 may include a single core or a plurality of cores. Processor circuit 120 may be a general purpose processor unit configured to execute a particular instruction set architecture, such as any one or more of Armv9, x86, RISC-V, and the like.

As illustrated, communication fabric 160 is configured to transfer transactions from source agents to destination agents, such as from processor circuit 120 to memory circuit 130a. Although illustrated as a single block, communication fabric 160 may comprise a plurality of different networks coupling various circuit blocks, including ones that are not illustrated for clarity. For example, communication fabric 160 may include a first network for coupling a plurality of processor cores to one another, a second network for coupling memory circuits to processor cores and other circuits, and a third network for coupling various peripheral circuits (e.g., input/output circuits, communication circuits such as USB, ethernet, and Bluetooth, cryptography accelerators, display circuits, audio circuits, and the like). These networks may further include various network switches, routers, and interfaces for transferring transactions from the various source agents, including transferring these transactions across different ones of the networks, to the various destination agents.

Memory circuits 130a and 130b (collectively 130) may include any suitable type of random-access memory (RAM). For example, memory circuits 130 may include one or more static RAM (SRAM) arrays included on the one or more ICs comprising computer system 100. In addition to, or in place of, SRAM circuits, memory circuits 130 may include one or more memory controllers configured to access one or more off-chip dynamic RAM (DRAM) circuits. Furthermore, storage device 170 is shown as being coupled to computer system 100. In other embodiments, storage device 170 may be included within computer system 100. Storage device 170 may be a non-volatile storage circuit such as a hard-disk drive, a solid-state drive, an optical media drive, and the like. It is contemplated that storage device 170 may include two or more such devices. Storage device 170 may store any suitable type of information to be used by computer system 100 including, for example, instructions and data associated with booting computer system 100.

As shown, storage device 170 is coupled to physical interface circuit 140. Physical interface circuit 140 may include various physical wiring (e.g., metal lines in an IC, input/output pin logic, bond wires, package pins, circuit board traces and similar elements to couple storage device 170 to computer system 100. Physical interface circuit 140 may further include various tuning circuits configured to adjust signal propagation delays when sending and/or receiving information to/from storage device 170. In some embodiments, physical interface circuit 140 may also include one or more data buffers/queues, bus arbitration circuits, and such to enable reliable high-speed communication with storage device 170.

Physical interface circuit 140 may be configured to operate in a selectable one of a plurality of modes 115. Modes 115 includes a firmware-based mode, a first hardware-based mode, and a second hardware-based mode. In the first and second hardware-based modes, the tuning circuits of physical interface circuit 140 may be set by hardware circuits within physical interface controller circuit 110. Accordingly, the first and second hardware-based modes may be available after computer system 100 powers on. In the firmware-based mode, the tuning circuits of physical interface circuit 140 may be set based on execution of firmware 155 that has been loaded into memory circuit 130b. The firmware-based mode, therefore, is not available until after firmware 155 has been loaded into memory circuit 130b. Hardware-based modes may be used to implement older standards in which operation of physical interface circuit 140 is well-known and predictable. Firmware-based modes, in contrast, may be used for newer standards in which operation of physical interface circuit 140 is less predictable, thereby allowing changes to the tuning circuits by a change of firmware rather than by redesigning hardware.

Physical interface controller circuit 110 is coupled to physical interface circuit 140 and is configured to manage physical interface circuit 140 by, for example, setting the tuning circuits, selecting a mode of modes 115 in which to operate, transferring information into/out of data buffers, and the like. As illustrated, physical interface controller circuit 110 may be configured to support any one of a plurality of communication interface standards, including, for example, PCIe, SATA, USB, or other such standards. In some embodiments, physical interface controller circuit 110 may be configured to support one or more proprietary communication interfaces.

As shown, physical interface controller circuit 110 may also be configured to, upon a boot of computer system 100, operate physical interface circuit 140 in the first hardware-based mode to load, from storage device 170, at least a first portion of boot code 150 into a first one of memory circuits 130 (e.g., memory circuit 130a). Boot code 150 may be executable by processor circuit 120 to perform various boot operations including an initialization of various circuits within and/or coupled to computer system 100. Identifier 117 included in physical interface controller circuit 110 may provide an indication to processor circuit 120 that physical interface controller circuit 110 is configured as an eligible (e.g., primary) boot code source for computer system 100. Processor circuit 120 may be configured to select an available boot code source such as physical interface controller circuit 110, e.g., by executing basic input/output system (BIOS) instructions from a read-only memory (ROM) coupled to processor circuit 120.

After execution of the first portion of boot code 150 by processor circuit 120, physical interface controller circuit 110 may be further configured to operate physical interface circuit 140 in the second hardware-based mode to load firmware 155 into a second one of memory circuits 130 (e.g., memory circuit 130b). Firmware 155 may include instructions that are executable by a processing circuit within physical interface controller circuit 110, execution of the firmware causing the processing circuit to configure physical interface circuit 140 for operation in the firmware-based mode. In some embodiments, firmware 155 may be much larger than the first portion of boot code 150. For example, boot code 150 may be a few kilobytes to tens of kilobytes of code, while firmware 155 may be on the order of hundreds of kilobytes of code, e.g., one to two orders of magnitude bigger than boot code 150. Accordingly, physical interface controller circuit 110 may be configured to switch physical interface circuit 140 into the second hardware-based mode if, for example, the second hardware-based mode has a data-rate that is greater than a data-rate of the first hardware-based mode, thus reducing an amount of time used to download firmware 155 from storage device 170.

In some embodiments, physical interface controller circuit 110 may be further configured to, after execution of firmware 155, operate physical interface circuit 140 in the firmware-based mode to load a remainder of boot code 150. Once firmware 155 has been downloaded and is thereby available for use, physical interface controller circuit 110 may execute firmware 155 to enable the firmware-based mode. For example, the firmware-based mode may have a higher data-rate than the first and second hardware-based modes, thereby further reducing an amount of time for completing the boot operation.

It is noted that computer system 100, as illustrated in FIG. 1, is merely an example. The illustration of FIG. 1 has been simplified to highlight features relevant to this disclosure. Various embodiments may include different configurations of the circuit elements. For example, additional elements may include power and/or clock management circuits. Although a single physical interface circuit is shown, in other embodiments, any suitable number of physical interface circuits (and/or other external interface circuits) may be included. In various embodiments, circuits of computer system 100 may be implemented using any suitable combination of sequential and combinatorial logic circuits. In addition, register and/or memory circuits, such as SRAM, may be used in these circuits to temporarily hold information such as instructions, data, address values, and the like.

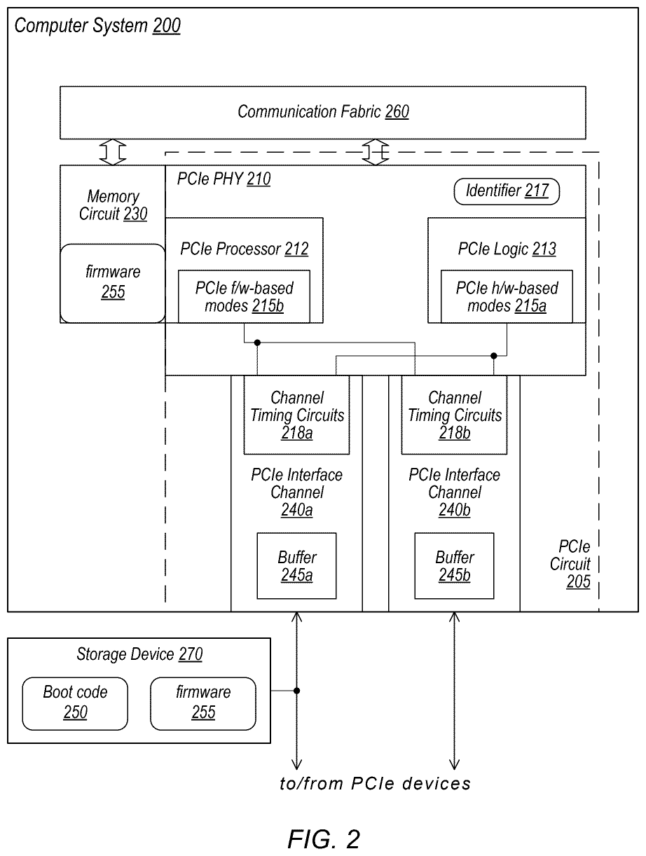

FIG. 1 illustrates an embodiment of a system utilizing the disclosed techniques to use, for downloading boot code and firmware, a physical interface circuit that relies on the firmware for at least portions of operation. As described, the physical interface circuit of this example may support any of a variety of communication standards. A particular example of a PCIe interface is depicted in FIG. 2.

Moving to FIG. 2, a block diagram of an embodiment of a computer system with a two channel PCIe interface circuit is shown. Computer system 200 includes several elements also depicted in FIG. 1, such as communication fabric 260 and memory circuit 230, which in some embodiments, may correspond to communication fabric 160 and one or both of memory circuits 130. Accordingly, descriptions of such elements are the same as disclosed above with any exceptions detailed below. Computer system 200 further includes PCIe PHY 210 coupled to PCIe interface channels 240a and 240b (collectively 240). PCIe PHY 210 and PCIe interface channels 240 may correspond to particular implementations of physical interface controller circuit 110 and physical interface circuit 140, respectively. PCIe interface channels 240 include respective channel timing circuits 218a and 218b (collectively 218) as well as respective buffers 245a and 245b (collectively 245). PCIe PHY 210, as shown, includes PCIe processor 212 and PCIe logic 213.

In a similar manner as computer system 100, computer system 200 may be implemented on one or more co-packaged integrated circuit dies. As illustrated, computer system 200 includes peripheral component interconnect express (PCIe) circuit 205 that may be configured to operate in a plurality of modes, including first and second PCIe hardware-based modes 215a and at least one PCIe firmware-based mode 215b. PCIe circuit 205 includes PCIe interface channels 240a and 240b. PCIe interface channel 240a may be a general-purpose channel configured to interface to a variety of PCIe-supported devices. PCIe interface channel 240b may be a storage channel configured to interface with PCIe-supported storage devices. Each of PCIe interface channels 240 includes a respective one of buffers 245 which may be used to buffer data after being received and/or to buffer data that is scheduled to be sent. PCIe circuit 205 also includes PCIe physical layer circuit (PHY) 210 that includes an embedded microprocessor circuit, PCIe processor 212, that may be configured to execute communication firmware 255 to implement PCIe firmware-based modes 215b.

In the present example, PCIe hardware-based modes 215a may include PCIe generations 1-4, while PCIE firmware-based modes may include PCIe generations 5-6. In other embodiments, the split between hardware-based modes and firmware-based modes may differ. Each generation of PCIe includes a respective set of specifications for signals used to transfer information, with latest generations (e.g., higher number) typically supporting data rates that are twice the preceding generation. Use of PCIe firmware-based modes 215b may allow circuit designers some flexibility in how PCIe PHY 210 is designed by enabling use of firmware updates to alter how channel timing circuits 218 are configured for sending and receiving the high-speed signals used with the latest PCIe generations. In contrast, modifying PCIe logic circuits to alter how channel timing circuits 218 are configured would require a lengthy and costly redesign of one or more ICs included in computer system 200.

As shown, storage device 270 is coupled to PCIe circuit 205 via PCIe interface channel 240a, and may be configured to support a second plurality of modes including at least the first and second modes of PCIe hardware-based modes 215a. Although PCIe interface channel 240a may be designated for use with general purpose peripherals, it may still support communication with any storage device that supports at least one of PCIe generations 1-6. For example, a design of PCIe PHY 210 may be reused across a variety of IC designs, and some of these IC designs may include a single PCIe interface channel. Accordingly, this single PCIe interface channel may be used to communicate with storage devices as well as other devices such as graphics processors, artificial intelligence engines, and the like.

PCIe circuit 205 may be configured to, based on an indication to boot computer system 200, download, from storage device 270 using the first of PCIe hardware-based modes 215a (e.g., gen 1), at least a first portion of boot code 250. For example, PCIe circuit 205 may include a logical identifier 217 that indicates that PCIe circuit 205 (PCIe PHY 210 in particular) is designated as a boot controller. In embodiments in which more than one PCIe PHY are included, identifier 217 may be used to indicate that PCIe PHY 210 is enabled as a valid boot controller. In some of these embodiments, identifier 217 may further indicate that PCIe interface channel 240a is a valid for downloading boot code 250. This logical identifier 217 may be invariant with respect to a total number of instances of PCIe circuit 205. Accordingly, if the design of PCIe circuit 205 is used in multiple different ICs, PCIe circuit 205 will be designated as a valid boot controller for each of these different ICs, thereby creating a standardized boot procedure across the different ICs.

As illustrated, PCIe circuit 205 may be configured to use the general-purpose PCIe interface channel 240a to download the first portion of boot code 250 as well as PCIe firmware 255. Upon execution of the first portion of boot code 250, PCIe circuit 205 may be further configured to download, from storage device 270, firmware 255 using the second of hardware-based modes 215a (e.g., gen 2). PCIe firmware 255 may be stored in memory circuit 230 that is coupled to PCIe PHY 210, thereby enabling access to the stored version of firmware 255 by PCIe processor 212.

After firmware 255 has been stored in memory circuit 230, PCIe circuit 205 may be further configured to execute, while in one of firmware-based modes 215b, PCIe firmware 255 to adjust timing of signals sent via PCIe circuit 205 as well as adjust timing for sampling data signals received via PCIe circuit 205. As disclosed above, firmware 255 may cause PCIe processor 212 to adjust a configuration of channel timing circuits 218 to support the higher speed PCIe generations such as gen 5 and/or gen 6. At the time of this disclosure, gen 6 is the newest and fastest generation. It is contemplated, however, that subsequent, currently unpublished, generations of PCIe may be implemented using similar techniques as disclosed herein.

In some embodiments, PCIe PHY 210 may include a first PCIe processor circuit and a second PCIe processor circuit in which PCIe circuit 205 may be further configured to use the first processor circuit to operate the general-purpose PCIe interface channel 240a in the firmware-based modes 215b, and use the second processor circuit to operate the storage PCIe interface channel in the firmware-based modes 215b. For example, instead of a single PCIe processor 212, separate PCIe processors 212a and 212b (not shown) are used to manage each PCIe interface channel 240a and 240b, respectively. In such an embodiment, PCIe circuit 205 may be further configured to concurrently store firmware 255 in first and second locations of memory circuit 230 for use by PCIe processors 212a and 212b, respectively.

PCIe circuit 205 may be further configured to, upon a reboot of computer system 200, operate PCIe interface channel 240a in the first of hardware-based modes 215a to load at least the first portion of boot code 250. In a soft reboot of computer system 200 (e.g., a reboot in which system power has not been lost since an initial power-on boot), firmware 255 may remain valid in memory circuit 230. Despite having a valid copy of firmware 255 in memory circuit 230, PCIe circuit 205 may be configured to, after a subsequent execution of the first portion of boot code 250 by a processor circuit (not shown) in computer system 200, operate PCIe interface channel 240a in the second of hardware-based modes 215a to reload firmware 255 to memory circuit 230. The reloading of boot code 250 and firmware 255 in response to a soft boot may enable a consistent boot operation (or a consistent portion of the boot operation) regardless of a current state of computer system 200. Such a consistent boot operation may mitigate at least some issues that may have led to the soft reboot, such as a runaway code event. In addition, the consistent boot operation may make implementation across various types of computer systems easier for designers and programmers by eliminating variables between the different types.

It is noted that the embodiment of FIG. 2 is an example of implementing the disclosed techniques using a PCIe circuit. In other embodiments, a different combination of elements may be included. Although two PCIe interface channels are shown, any suitable number of channels may be included in other embodiments. Additional elements, such as one or more processor circuits, additional memory circuits, clock and power management circuits, and the like may be included in other embodiments.

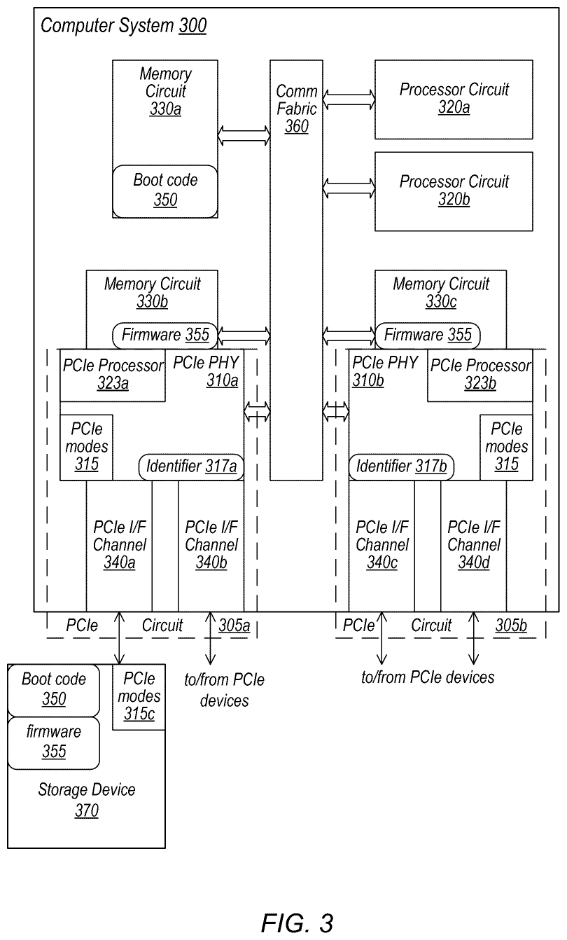

In the description of FIGS. 1 and 2, computer systems 100 and 200 are each shown with a single physical interface controller circuit (e.g., PCIe PHY). It is contemplated that some systems may include more than one physical interface controller circuit. An embodiment of a system that includes two physical interface controller circuits is shown in FIG. 3.

Turning to FIG. 3, an embodiment of a computer system that includes two PCIe circuits, each with a respective processor circuit, is depicted. Computer system 300 may, in some embodiments, be an expansion of computer system 200 in FIG. 2. For example, computer systems 200 and 300 may be implemented as multi-chiplet designs in which an additional or a different chiplet may be included to add the second PCIe circuit and respective memory circuit. In other embodiments, computer system 300 may be a different IC design from computer system 200, but utilizing similar circuit designs. Computer system 300 includes Processor circuits 320a and 320b (collectively 320), memory circuits 330a-330c (collectively 330), and communication fabric 360. As stated, computer system 300 includes PCIe circuits 305a and 305b (collectively 305), each with two respective ones of PCIe interface channels 340. Storage device 370 is coupled to PCIe interface channel 340a of PCIe circuit 305a.

Computer system 300, as depicted, includes PCIe circuit 305a that is configured to operate in a plurality of PCIe modes 315, including a firmware-based mode. In a similar manner as described for computer system 200, one of processor circuits 320 (e.g., 320a) may, in response to an indication to perform a boot operation for computer system 300, configure PCIe interface channel 340a of PCIe circuit 305a for a first hardware-based mode of PCIe modes 315 to download at least a first portion of boot code 350 to store in memory circuit 330a. Processor circuit 320a may then configure PCIe interface channel 340a for a second hardware-based mode of PCIe modes 315a to download firmware 355 into memory circuit 330b.

As illustrated, computer system 300 also includes a PCIe circuit 305b that, like PCIe circuit 305a, is configured to operate in the plurality of PCIe modes 315, including the firmware-based mode. In some embodiments, PCIe circuit 305b may be a same or similar design as PCIe circuit 305a. In such embodiments, PCIe processor 323b in PCIe PHY 310b may be code compatible with PCIe processor 323a in PCIe PHY 310a. Accordingly, both PCIe processors 323a and 323b may be capable of using the same firmware 355. To reduce an amount of time to complete the boot operation, PCIe circuit 305a may be further configured to store firmware 355 into memory circuit 330c for use with PCIe PHY 310b concurrent with storing firmware 355 into memory circuit 330b for use with PCIe PHY 310a, resulting in firmware 355 being read once for a given boot operation.

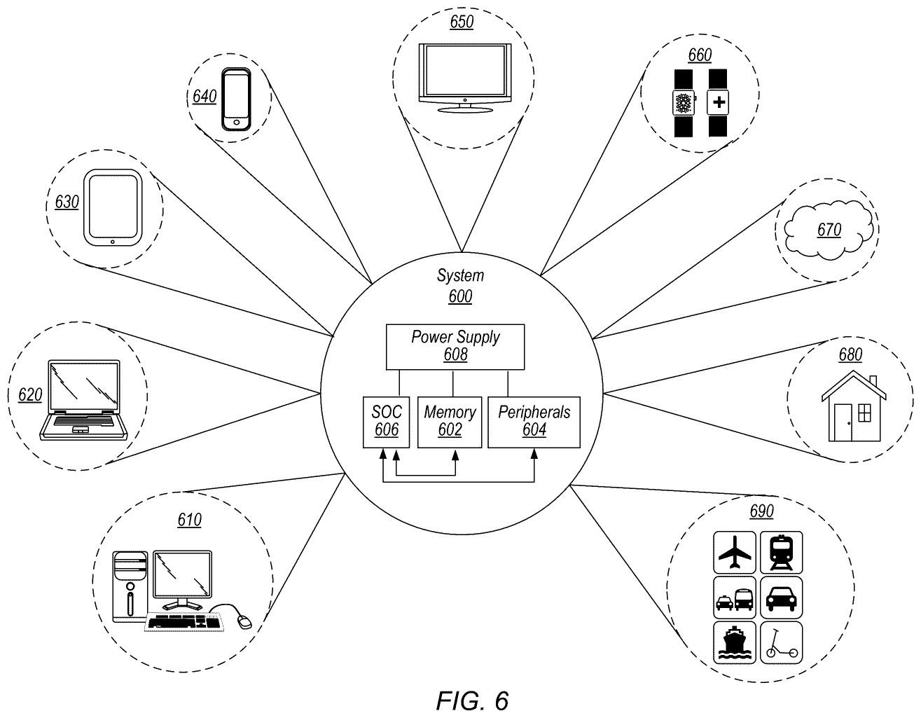

Each of PCIe PHYs 310 includes a respective one of identifiers 317a and 317b. Identifier 317a may identify PCIe PHY 310a as a valid boot controller. Identifier 317b may be different from identifier 317a and, therefore, may not identify PCIe PHY 310b as a valid boot controller. Accordingly, identifier 317a may be invariant with respect to a total number of instances of PCIe PHYs within computer system 300. For example, if computer system 300 includes four or more PCIe circuits 305, only PCIe circuit 305a would include identifier 317a identifying PCIe circuit 305a as the valid boot controller out of the four or more PCIe circuits 305. The same identifier 317a may further be used to indicate the valid boot controller in other computer systems regardless of a number of PCIe circuits included in these computer systems. Use of a same identifier 317a to indicate the valid boot controller may support a common boot procedure across a family of computer systems, regardless of the type of computer system, e.g., laptop or desktop computer, smart phone, tablet computer, wearable devices, and other such smart devices such as will be discussed in more detail below in regard to FIG. 6.

Identifier 317a may be assigned to the selected boot controller of a plurality of PCIe circuits 305 using circuit design information, such as instructions of a hardware description programming language. Such instructions may include variables to be set for each instance of PCIe circuit 305 included in a given IC design. In addition, these instructions may be further programmable to include a selectable number of physical interface channels, such as the two channels shown for each instance of PCIe circuit 305 in computer system 300. The instructions may further cause a respective PCIe PHY 310 in the selected boot controller to use a particular one of the number of PCIe interface channels for use with the common boot procedure, regardless of the number of channels included in a given implementation.

It is noted that computer system 300 of FIG. 3 merely demonstrates disclosed concepts. Computer system 300 has been simplified to clearly illustrate the described elements for implementing the described techniques. In other embodiments, additional elements may be included. For example, although two PCI circuits are shown in FIG. 3, each with two respective PCIe interface channels, any suitable number of PCIe circuits may be included in a given computer system and each of the included PCIe circuits, may include a respective number of PCIe interface channels, independent of the number of channels in the other instances of the PCIe circuits.

To summarize, various embodiments of an apparatus may include a computer system implemented on one or more co-packaged integrated circuit dies. The computer system may include one or more processor circuits configured to execute boot code to perform a boot sequence for the computer system, a physical interface circuit, and a physical interface controller circuit for the physical interface circuit. The physical interface circuit may be configured to operate in a plurality of modes, including a firmware-based mode, a first hardware-based mode, and a second hardware-based mode. The physical interface controller circuit, may be coupled to one or more memory circuits, and may be configured to, upon a boot of the computer system, operate the physical interface circuit in the first hardware-based mode to load, from a storage device coupled to the physical interface circuit, at least a first portion of boot code into a first one of the one or more memory circuits. After execution of the first portion of the boot code by the one or more processor circuits, the physical interface controller circuit may be further configured to operate the physical interface circuit in the second hardware-based mode to load communication firmware into a second one of the one or more memory circuits.

In a further example, the second hardware-based mode may have a data-rate that is greater than a data-rate of the first hardware-based mode. In an example, the physical interface controller circuit may be further configured to, after execution of the communication firmware, operate the physical interface circuit in the firmware-based mode to load a remainder of the boot code. In another example, the firmware-based mode may have a higher data-rate than the first and second hardware-based modes.

In an example, the physical interface controller circuit may be a first physical interface controller circuit. The computer system may further include a second physical interface circuit configured to operate in the plurality of modes, including the firmware-based mode, and a second physical interface controller circuit configured to operate the second physical interface circuit. The first physical interface controller circuit may be further configured to concurrently store the communication firmware in the second memory circuit that is coupled to the first physical interface controller circuit and to a third one of the one or more memory circuits that is coupled to the second physical interface controller circuit.

In a further example, the physical interface controller circuit may be further configured to execute, while in the firmware-based mode, the communication firmware to adjust timing of signals sent via the physical interface circuit, and to adjust timing for sampling data signals received via the physical interface circuit. In an example, a logical identifier of the physical interface controller circuit may identify the physical interface controller circuit as a boot controller, wherein the logical identifier is invariant with respect to a total number of instances of the physical interface controller circuit within the computer system. In another example, the physical interface circuit may be a peripheral component interconnect express (PCIe) channel and the physical interface controller circuit is a PCIe physical layer circuit that includes an embedded microprocessor circuit configured to execute the communication firmware to implement the firmware-based mode.

In a further example, the physical interface controller circuit may be further configured to, upon a reboot of the computer system in which the communication firmware remains valid in the second memory circuit, operate the physical interface circuit in the first hardware-based mode to load at least the first portion of boot code. The physical interface controller circuit may also be configured to, after a subsequent execution of the first portion of the boot code by the one or more processor circuits, operate the physical interface circuit in the second hardware-based mode to load the communication firmware to the second memory circuit.

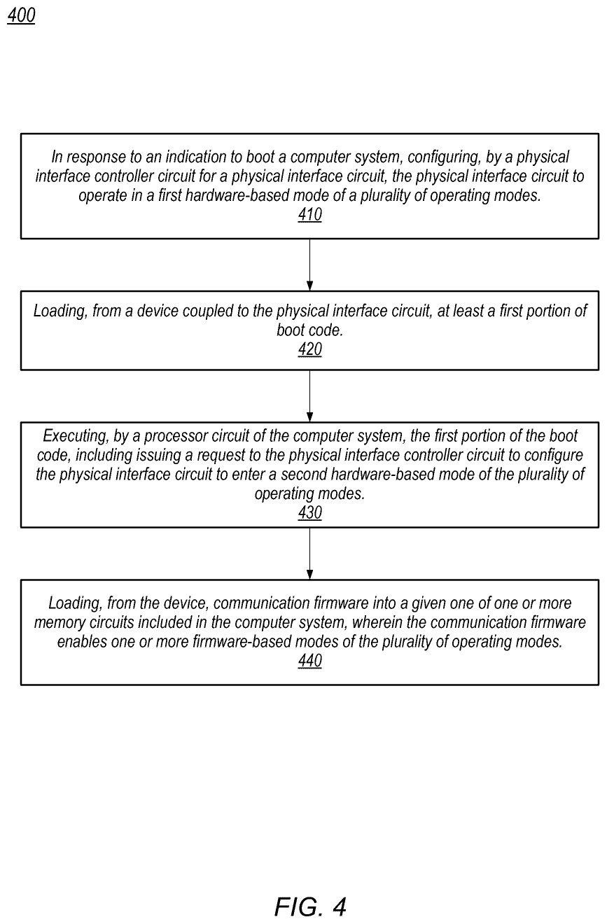

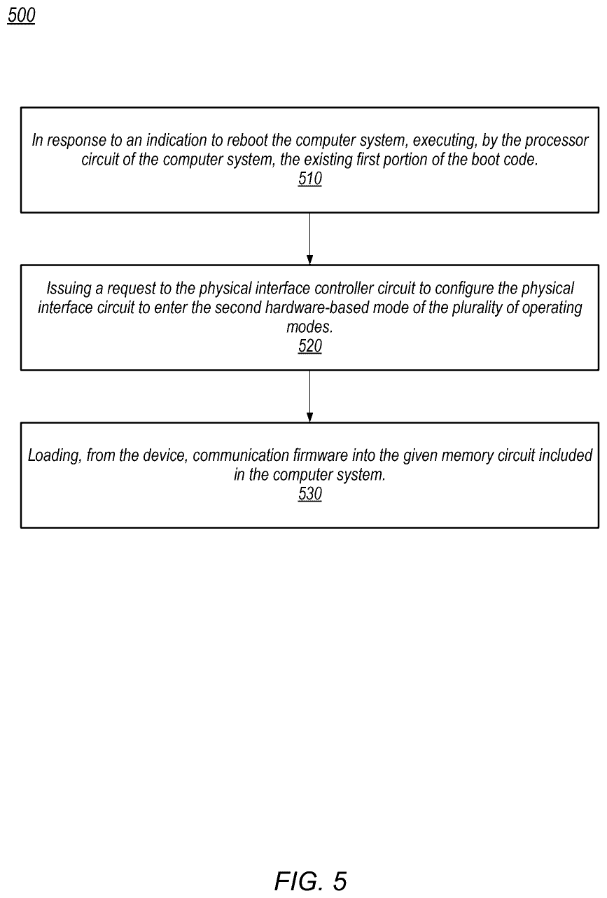

The circuits and techniques described above in regards to FIGS. 1-3 illustrate computer systems that include physical interface circuits that operate in a plurality of modes, including at least one firmware-based mode and a plurality of hardware-based modes. These computer systems may function using a variety of methods. Two such methods are described below in regards to FIGS. 4-5. In some embodiments, the operations of the disclosed methods may be performed, in whole or in part, using instructions included in a non-transient, computer-readable memory having program instructions being executable by processor circuits in the systems to cause the operations described with reference to FIGS. 4-5.

Moving now to FIG. 4, a flow diagram for an embodiment of a method for booting a computer system that includes a physical interface circuit with a physical interface controller circuit is shown. Method 400 may be performed by any of the computer systems disclosed herein, including any of computer systems 100-300 in FIGS. 1-3. Referring collectively to FIGS. 1 and 4, method 400 begins in block 410.

At block 410, method 400 begins with a physical interface controller circuit for a physical interface circuit configuring, in response to an indication to boot a computer system, the physical interface circuit to operate in a first hardware-based mode of a plurality of operating modes. For example, computer system 100, which may be implemented on one or more co-packaged integrated circuit dies, may generate an indication to perform a boot operation. Such an indication may be generated by any suitable circuit within computer system 100, such as a power management system in response to a power-on event. In response to the indication, processor circuit 120 may read an perform a first set of instructions, such as instructions from a ROM BIOS, causing processor circuit 120 to configure physical interface controller circuit 110 to implement a first mode of modes 115, corresponding to the first hardware-based mode.

Method 400, at block 420, continues with a physical interface circuit loading, from a device coupled to the physical interface circuit, at least a first portion of boot code. For example, physical interface controller circuit 110 may configure physical interface circuit 140 for the first hardware-based mode and then retrieve the first portion of boot code 150 from storage device 170. Processor circuit 120 may use logical identifier 117 that identifies physical interface controller circuit 110 as a boot controller. In some embodiments, identifier 117 may be invariant with respect to a total number of instances of the physical interface controller circuits within computer system 100. For example, a same value of identifier 117 may be used to identify a valid boot controller across a variety of computer systems, regardless of how many physical interface controller circuits are included the computer system.

At block 430, method 400 proceeds with a processor circuit of the computer system executing the first portion of the boot code, including issuing a request to the physical interface controller circuit to configure the physical interface circuit to enter a second hardware-based mode of the plurality of operating modes. Processor circuit 120 may, for example, cause physical interface controller circuit 110 to switch to the second hardware-based mode. The second hardware-based mode may have a data-rate that is greater than a data-rate of the first hardware-based mode.

Method 400 continues at block 440 with loading, from the device, communication firmware into a given one of one or more memory circuits included in the computer system. The communication firmware may enable one or more firmware-based modes of the plurality of operating modes. For example, after entering the second hardware-based mode, physical interface controller circuit 110 may use physical interface circuit 140 to download firmware 155 from storage device 170. In some embodiments, firmware 155 may be larger than boot code 150. For example, boot code 150 may be tens or hundreds of bytes of code while firmware 155 may be thousands of bytes of code. Accordingly, the higher data-rate of the second hardware-based mode may reduce an amount of time for downloading firmware 155 and allow computer system 100 to reach an operable state for a user faster than downloading firmware 155 using the first hardware-based mode.

Method 400 may end in block 440. In some embodiments, all or a portion of method 400 may repeat. For example, computer system 100 may be an instance of a particular computing platform of a plurality of different computing platforms that include respective instances of the physical interface controller circuit and the physical interface circuit, and wherein the respective instances of the physical interface controller circuit are usable within the plurality of different computing platforms to perform a common boot procedure. In such a computing platform, each instance of the computer system may perform the operations of method 400 in a concurrent manner.

In some embodiments, after execution of the communication firmware 155, physical interface controller circuit 110 may cause physical interface circuit 140 to operate in one of the firmware-based modes of modes 115 to load a remainder of the boot code. The firmware-based mode may have a higher data-rate than the second hardware-based mode.

Method 400 may be used, in some embodiments, in response to a power-on boot operation of the computer system. A different method, such as depicted in FIG. 5, may be used in response to a soft reboot of the computer system, e.g., a reboot that is not a result of a power-on event.

Proceeding now to FIG. 5, a flow diagram for an embodiment of a method for rebooting the computer system of FIG. 4 is illustrated. In a similar manner as method 400, method 500 may also be performed by any of disclosed computer systems 100-300 in FIGS. 1-3. In some embodiments, method 500 may be performed subsequent to method 400. Referring collectively to FIGS. 1 and 5, method 500 begins in block 510 after block 440 of method 400 has been performed.

At block 510, method 500 begins with a processor circuit of the computer system executing, in response to an indication to reboot the computer system, the existing first portion of the boot code. An indication to reboot the computer system may be generated in response to a system watchdog circuit asserting a reset signal, an attempt to execute an invalid instruction, an attempt to access an unimplemented or unauthorized address in a system memory map, and other such events.

Method 500 continues at block 520 with the processor circuit issuing a request to the physical interface controller circuit to configure the physical interface circuit to enter the second hardware-based mode of the plurality of operating modes. The second hardware-based mode may have a higher data rate than the first hard-ware based mode.

At block 530, method 500 proceeds with loading, from the device, communication firmware into the given memory circuit included in the computer system. As disclosed above, the boot code and firmware may be reloaded despite valid copies of the code remaining in the respective memory locations.

As described above for method 400, after execution of the communication firmware 155, in some embodiments, physical interface controller circuit 110 may cause physical interface circuit 140 to operate in one of the firmware-based modes of modes 115 to load a remainder of the boot code. This firmware-based mode may have a higher data-rate than the second hardware-based mode.

Method 500 may end in block 530, or may repeat one or more blocks. For example, block 530 may repeat, or two instances may be performed concurrently, to load the firmware into respective memory locations for different physical interface controller circuits, such as described above in regard to FIG. 3.

FIGS. 1-5 illustrate apparatus and methods for a computer system that includes a physical interface circuit with a physical interface controller circuit that operates in two or more hardware-based modes and at least one firmware-based mode. Any embodiment of the disclosed systems may be included in one or more of a variety of computer systems, such as a desktop computer, laptop computer, smartphone, tablet, wearable device, and the like. In some embodiments, the circuits described above may be implemented on a system-on-chip (SOC) or other type of integrated circuit. In other embodiments, the circuits described above may be implemented in a multi-die computer system including a multi-chiplet system. A block diagram illustrating an embodiment of computer system 600 is illustrated in FIG. 6. Computer system 600 may, in some embodiments, include any disclosed embodiment of computer systems 100-300.

In the illustrated embodiment, the system 600 includes at least one instance of a system on chip (SOC) 606 which may include multiple types of processing circuits, such as a central processing unit (CPU), a graphics processing unit (GPU), or otherwise, a communication fabric, and interfaces to memories and input/output devices. In some embodiments, SOC 606 corresponds to one of the disclosed computer systems 100-300. Various portions of the disclosed elements of SOC 606 may be implemented on one or more chiplets comprising SOC 606. In some embodiments, one or more processors in SOC 606 includes multiple execution lanes and an instruction issue queue. In various embodiments, SOC 606 is coupled to external memory 602, peripherals 604, and power supply 608.

A power supply 608 is also provided which supplies the supply voltages to SOC 606 as well as one or more supply voltages to the memory 602 and/or the peripherals 604. In various embodiments, power supply 608 represents a battery (e.g., a rechargeable battery in a smart phone, laptop or tablet computer, or other device). In some embodiments, more than one instance of SOC 606 is included (and more than one external memory 602 is included as well).

The memory 602 is any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices are coupled onto a circuit board to form memory modules such as single inline memory modules (SIMMs), dual inline memory modules (DIMMs), etc. Alternatively, the devices are mounted with a SOC or an integrated circuit in a chip-on-chip configuration, a package-on-package configuration, or a multi-chip module configuration.

The peripherals 604 include any desired circuitry, depending on the type of system 600. For example, in one embodiment, peripherals 604 includes devices for various types of wireless communication, such as Wi-Fi, Bluetooth, cellular, global positioning system, etc. In some embodiments, the peripherals 604 also include additional storage, including RAM storage, solid state storage, or disk storage. The peripherals 604 include user interface devices such as a display screen, including touch display screens or multitouch display screens, keyboard or other input devices, microphones, speakers, etc.

As illustrated, system 600 is shown to have application in a wide range of areas. For example, system 600 may be utilized as part of the chips, circuitry, components, etc., of a desktop computer 610, laptop computer 620, tablet computer 630, cellular or mobile phone 640, or television 650 (or set-top box coupled to a television). Also illustrated is a smartwatch and health monitoring device 660. In some embodiments, the smartwatch may include a variety of general-purpose computing related functions. For example, the smartwatch may provide access to email, cellphone service, a user calendar, and so on. In various embodiments, a health monitoring device may be a dedicated medical device or otherwise include dedicated health related functionality. For example, a health monitoring device may monitor a user's vital signs, track proximity of a user to other users for the purpose of epidemiological social distancing, contact tracing, provide communication to an emergency service in the event of a health crisis, and so on. In various embodiments, the above-mentioned smartwatch may or may not include some or any health monitoring related functions. Other wearable devices 660 are contemplated as well, such as devices worn around the neck, devices attached to hats or other headgear, devices that are implantable in the human body, eyeglasses designed to provide an augmented and/or virtual reality experience, and so on.

System 600 may further be used as part of a cloud-based service(s) 670. For example, the previously mentioned devices, and/or other devices, may access computing resources in the cloud (i.e., remotely located hardware and/or software resources). Still further, system 600 may be utilized in one or more devices of a home 680 other than those previously mentioned. For example, appliances within the home may monitor and detect conditions that warrant attention. Various devices within the home (e.g., a refrigerator, a cooling system, etc.) may monitor the status of the device and provide an alert to the homeowner (or, for example, a repair facility) should a particular event be detected. Alternatively, a thermostat may monitor the temperature in the home and may automate adjustments to a heating/cooling system based on a history of responses to various conditions by the homeowner. Also illustrated in FIG. 6 is the application of system 600 to various modes of transportation 690. For example, system 600 may be used in the control and/or entertainment systems of aircraft, trains, buses, cars for hire, private automobiles, waterborne vessels from private boats to cruise liners, scooters (for rent or owned), and so on. In various cases, system 600 may be used to provide automated guidance (e.g., self-driving vehicles), general systems control, and otherwise.

It is noted that the wide variety of potential applications for system 600 may include a variety of performance, cost, and power consumption requirements. Accordingly, a scalable solution enabling use of one or more integrated circuits to provide a suitable combination of performance, cost, and power consumption may be beneficial. As described above, the common boot operation disclosed herein may be performed consistently regardless of which of the potential applications in which any of computer systems 100-300 are included. These and many other embodiments are possible and are contemplated. It is noted that the devices and applications illustrated in FIG. 6 are illustrative only and are not intended to be limiting. Other devices are possible and are contemplated.

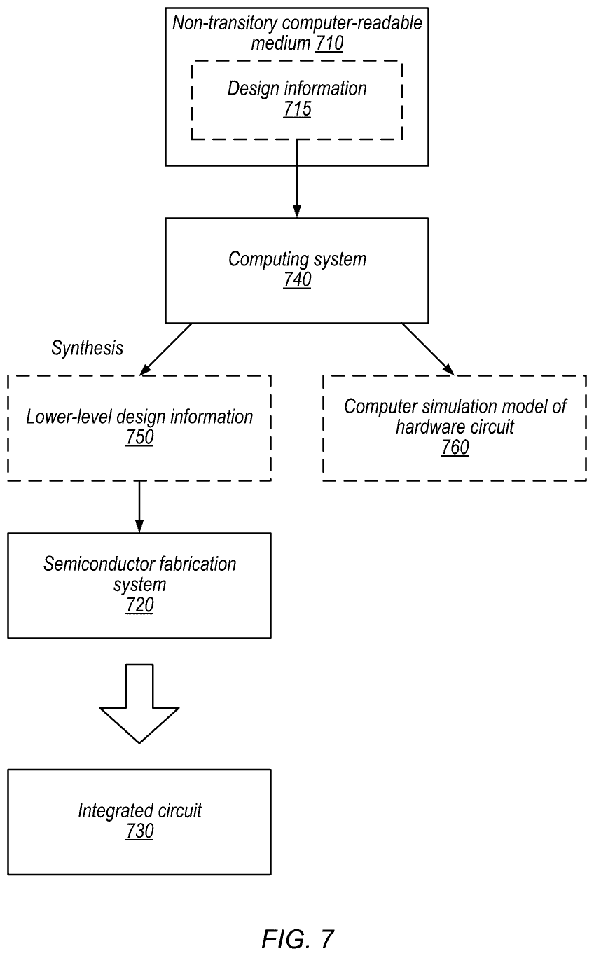

As disclosed in regards to FIG. 6, computer system 600 may include any suitable number of integrated circuits coupled together and included within a personal computer, smart phone, tablet computer, or other type of computing device. A process for designing and producing an integrated circuit using design information is presented below in FIG. 7.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

FIG. 7 is a block diagram illustrating an example non-transitory computer-readable storage medium that stores circuit design information, according to some embodiments. In the illustrated embodiment, computing system 740 is configured to process the design information. This may include executing instructions included in the design information, interpreting instructions included in the design information, compiling, transforming, or otherwise updating the design information, etc. Therefore, the design information controls computing system 740 (e.g., by programming computing system 740) to perform various operations discussed below, in some embodiments.

In the illustrated example, computing system 740 processes the design information to generate both a computer simulation model of a hardware circuit 760 and lower-level design information 750. In other embodiments, computing system 740 may generate only one of these outputs, may generate other outputs based on the design information, or both. Regarding the computing simulation, computing system 740 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 740 also processes the design information to generate lower-level design information 750 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 750 (potentially among other inputs), semiconductor fabrication system 720 is configured to fabricate an integrated circuit 730 (which may correspond to functionality of the simulation model 760). Note that computing system 740 may generate different simulation models based on design information at various levels of description, including design information 750, 715, and so on. The data representing design information 750 and model 760 may be stored on medium 710 or on one or more other media.

In some embodiments, the lower-level design information 750 controls (e.g., programs) the semiconductor fabrication system 720 to fabricate the integrated circuit 730. Thus, when processed by the fabrication system, the design information may program the fabrication system to fabricate a circuit that includes various circuitry disclosed herein.

Non-transitory computer-readable storage medium 710, may comprise any of various appropriate types of memory devices or storage devices. Non-transitory computer-readable storage medium 710 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 710 may include other types of non-transitory memory as well or combinations thereof. Accordingly, non-transitory computer-readable storage medium 710 may include two or more memory media; such media may reside in different locations—for example, in different computer systems that are connected over a network.

Design information 715 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 740, semiconductor fabrication system 720, or both. In some embodiments, design information may also include one or more cell libraries that specify the synthesis, layout, or both of integrated circuit 730. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 730 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 720 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 720 may also be configured to perform various testing of fabricated circuits for correct operation.

In various embodiments, integrated circuit 730 and model 760 are configured to operate according to a circuit design specified by design information 715, which may include performing any of the functionality described herein. For example, integrated circuit 730 may include any of various elements shown in FIGS. 1B, 2, and 4. Further, integrated circuit 730 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program semiconductor fabrication system 720 to fabricate integrated circuit 730.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

For example, while the appended dependent claims are drafted such that each depends on a single other claim, additional dependencies are also contemplated, including the following: Claim 3 (could depend from any of claims 1-2); claim 4 (any preceding claim); claim 5 (claim 4), etc. Where appropriate, it is also contemplated that claims drafted in one statutory type (e.g., apparatus) suggest corresponding claims of another statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as “configured to” perform some task refers to something physical, such as a device, circuit, memory storing program instructions executable to implement the task, etc. This phrase is not used herein to refer to something intangible.

The hardware circuits may include any combination of combinatorial logic circuitry, clocked storage devices such as flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

The term “configured to” is not intended to mean “configurable to.” An unprogrammed FPGA, for example, would not be considered to be “configured to” perform some specific function. This unprogrammed FPGA may be “configurable to” perform that function, however.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

What is claimed is:

1. An apparatus, comprising:
a computer system implemented on one or more co-packaged integrated circuit dies, the computer system including:
one or more processor circuits configured to execute boot code to perform a boot sequence for the computer system;
a physical interface circuit configured to operate in a plurality of modes, including a firmware-based mode, a first hardware-based mode, and a second hardware-based mode; and
a physical interface controller circuit for the physical interface circuit, coupled to one or more memory circuits, wherein the physical interface controller circuit is configured to:
upon a boot of the computer system, operate the physical interface circuit in the first hardware-based mode to load, from a storage device coupled to the physical interface circuit, at least a first portion of boot code into a first one of the one or more memory circuits; and
after execution of the first portion of the boot code by the one or more processor circuits, operate the physical interface circuit in the second hardware-based mode to load communication firmware into a second one of the one or more memory circuits.

2. The apparatus of claim 1, wherein the second hardware-based mode has a data-rate that is greater than a data-rate of the first hardware-based mode.

3. The apparatus of claim 1, wherein the physical interface controller circuit is further configured to:
after execution of the communication firmware, operate the physical interface circuit in the firmware-based mode to load a remainder of the boot code.

4. The apparatus of claim 1, wherein the firmware-based mode has a higher data-rate than the first and second hardware-based modes.

5. The apparatus of claim 1, wherein the physical interface controller circuit is a first physical interface controller circuit, and the computer system further includes:
a second physical interface circuit configured to operate in the plurality of modes, including the firmware-based mode; and
a second physical interface controller circuit configured to operate the second physical interface circuit;
wherein the first physical interface controller circuit is configured to concurrently store the communication firmware in the second memory circuit that is coupled to the first physical interface controller circuit and to a third one of the one or more memory circuits that is coupled to the second physical interface controller circuit.

6. The apparatus of claim 1, wherein the physical interface controller circuit is further configured to execute, while in the firmware-based mode, the communication firmware to:
adjust timing of signals sent via the physical interface circuit; and
adjust timing for sampling data signals received via the physical interface circuit.

7. The apparatus of claim 1, wherein the physical interface controller circuit is further configured to:
upon a reboot of the computer system in which the communication firmware remains valid in the second memory circuit, operate the physical interface circuit in the first hardware-based mode to load at least the first portion of boot code; and
after a subsequent execution of the first portion of the boot code by the one or more processor circuits, operate the physical interface circuit in the second hardware-based mode to load the communication firmware to the second memory circuit.

8. The apparatus of claim 1, wherein a logical identifier of the physical interface controller circuit identifies the physical interface controller circuit as a boot controller, and wherein the logical identifier is invariant with respect to a total number of instances of the physical interface controller circuit within the computer system.

9. The apparatus of claim 1, wherein the physical interface circuit is a peripheral component interconnect express (PCIe) channel, and the physical interface controller circuit is a PCIe physical layer circuit that includes an embedded microprocessor circuit configured to execute the communication firmware to implement the firmware-based mode.

10. A method, comprising:
in response to an indication to boot a computer system that is implemented on one or more co-packaged integrated circuit dies:
configuring, by a physical interface controller circuit for a physical interface circuit, the physical interface circuit to operate in a first hardware-based mode of a plurality of operating modes;
loading, from a device coupled to the physical interface circuit, at least a first portion of boot code;
executing, by a processor circuit of the computer system, the first portion of the boot code, including issuing a request to the physical interface controller circuit to configure the physical interface circuit to enter a second hardware-based mode of the plurality of operating modes; and
loading, from the device, communication firmware into a given one of one or more memory circuits included in the computer system, wherein the communication firmware enables one or more firmware-based modes of the plurality of operating modes.

11. The method of claim 10, wherein the computer system is an instance of a particular computing platform of a plurality of different computing platforms that include respective instances of the physical interface controller circuit and the physical interface circuit, and wherein the respective instances of the physical interface controller circuit are usable within the plurality of different computing platforms to perform a common boot procedure.

12. The method of claim 11, wherein the particular computing platform is a mobile computing platform, and wherein a different instance of the physical interface controller circuit is usable within a different computer system that is an instance of a desktop computing platform.

13. The method of claim 10, further comprising using, by the physical interface controller circuit, a logical identifier that identifies the physical interface controller circuit as a boot controller, wherein the logical identifier is invariant with respect to a total number of instances of the physical interface controller circuit within the computer system.

14. The method of claim 10, wherein the second hardware-based mode has a data-rate that is greater than a data-rate of the first hardware-based mode.

15. The method of claim 14, further comprising operating, after execution of the communication firmware, the physical interface circuit in one of the firmware-based modes to load a remainder of the boot code, wherein the one firmware-based mode uses a higher data-rate than the second hardware-based mode.

16. A system, comprising:
a computer system implemented on one or more co-packaged integrated circuit dies, the computer system including a peripheral component interconnect express (PCIe) circuit that is configured to operate in a first plurality of modes, including first and second hardware-based modes and at least one firmware-based mode; and
a storage device coupled to the PCIe circuit and configured to support a second plurality of modes including the first and second hardware-based modes;
wherein the PCIe circuit is configured to:
based on an indication to boot the computer system, download, from the storage device using the first hardware-based mode, at least a first portion of boot code; and
upon execution of the first portion of the boot code, download, from the storage device using the second hardware-based mode, PCIe firmware into a memory circuit coupled to the PCIe circuit.

17. The system of claim 16, wherein the PCIe circuit includes a logical identifier that indicates the PCIe circuit is designated as a boot controller, and wherein the logical identifier is invariant with respect to a total number of instances of the PCIe circuit within the computer system.

18. The system of claim 16, wherein the PCIe circuit is further configured to execute, while in the firmware-based mode, the PCIe firmware to:
adjust timing of signals sent via the PCIe circuit; and
adjust timing for sampling data signals received via the PCIe circuit.

19. The system of claim 16, wherein the PCIe circuit includes a plurality of channels, including:
a general-purpose channel configured to interface to a variety of PCIe-supported devices; and
a storage channel configured to interface with PCIe-supported storage devices; and
wherein the PCIe circuit is configured to use the general-purpose channel to download the first portion of boot code and the PCIe firmware.

20. The system of claim 19, wherein the PCIe circuit includes a first processor circuit and a second processor circuit, and wherein the PCIe circuit is further configured to:
use the first processor circuit to operate the general-purpose channel in the firmware-based mode;
use the second processor circuit to operate the storage channel in the firmware-based mode; and
concurrently store the PCIe firmware in first and second locations of the memory circuit for use by the first and second processor circuits, respectively.
